(19) United States
(12) Patent Application Publication
(10) Pub. No.: US 2022/0272054 A1
(43) Pub. Date: Aug. 25, 2022

(54) COLLABORATE MULTIPLE CHATBOTS IN A SINGLE DIALOGUE SYSTEM

(71) Applicant: Robert Bosch GmbH, Stuttgart (DE)

(72) Inventor: Xiaoyang GAO, San Jose, CA (US)

(21) Appl. No.: 17/181,229

(22) Filed: Feb. 22, 2021

(51) Int. Cl. H04L 12/58; G06N 20/00; G06F 40/284; G06F 40/40

(52) U.S. Cl. CPC H04L 51/02; G06N 20/00; G06F 40/284; G06F 40/40

(57) ABSTRACT

Multiple chatbots are collaborated in a single chatbot dialogue system. The dialogue system is a computerized interactive system that receives inputs from users, and routs the inputs to appropriate assistant chatbots for further processing, if necessary. In embodiments disclosed herein, the system includes a master chatbot, and one or more assistant chatbots. The master chatbot is configured to receive an input, and determine an intent of the input. If the intent of the input matches a domain of the master chatbot, the master chatbot itself can process the intent. If the intent of the user instead matches a domain of one of the assistant chatbots, the master chatbot can forward the input to a corresponding one of the assistant chatbots for processing of the input. A forward flag can also be set when the input is forwarded such that any subsequent input can be automatically forwarded to the assistant chatbot.

### TECHNICAL FIELD

The present disclosure relates to systems, methods and framework to collaborate multiple chatbots in a single dialogue system.

### BACKGROUND

A chatbot is an artificial Intelligence (AI)-based application that can imitate a conversation with users in their natural language. A chatbot can react to user's requests and, in turn, deliver a particular service. A chatbot can rely on question-answer models which can employ large question-answer datasets to enable a computer, when provided a question, to provide an answer. A single chatbot may be too small and not sophisticated enough to fulfill needs of a variety of requests.

### SUMMARY

In an embodiment, a method for collaborating multiple chatbots in a dialogue setting is provided. The method includes: at a master chatbot, receiving a first input from a user; at the master chatbot, determining a first intent of the user based on the first input; in response to the master chatbot determining the first intent of the user matches a domain of the master chatbot, processing the first input via a first machine-learning model at the master chatbot; receiving a second input from the user at the master chatbot; at the master chatbot, determining a second intent of the user based on the second input; and in response to the master chatbot determining the second intent of the user matches a domain of an assistant chatbot in communication with the master chatbot: (i) setting a forward flag that corresponds to the assistant chatbot, (ii) forwarding the second input to the assistant chatbot for processing, and (iii) processing the second input via a second machine-learning model at the assistant chatbot.

In an embodiment, a non-transitory computer-readable storage medium comprising instructions that, when executed by at least one processor, cause the at least one processor to: at a master chatbot, receive an input from a user; at the master chatbot, determine an intent of the user based on the input; in response to the master chatbot determining the intent of the user is a first intent that matches a first domain of the master chatbot: (i) transform the input into a first output at the master chatbot utilizing a first machine-learning model, and (ii) deliver the first output to the user from the master chatbot; and in response to the master chatbot determining the intent of the user is a second intent that matches a second domain of an assistant chatbot in communication with the master chatbot: (i) set a forward flag to correspond with the assistant chatbot, (ii) forward the input to the assistant chatbot, (iii) transform the input into a second output at the assistant chatbot utilizing a second machine-learning model, (iv) send the second output from the assistant chatbot to the master chatbot, and (v) deliver the second output to the user from the master chatbot.

In an embodiment, a system for collaborating multiple chatbots in a dialogue setting is provided. The system includes a human-machine interface (HMI) configured to receive input from and provide output to a user; and one or more processors in communication with the HMI and programmed to: receive an input from the user via the HMI; at a master chatbot, determine an intent of the input; at the master chatbot, match the intent of the input with a domain of an assistant chatbot; set a forward flag that corresponds to the assistant chatbot; at the assistant chatbot, process the input to derive an output utilizing a machine-learning model; send the output from the assistant chatbot to the master chatbot; and deliver the output from the master chatbot to the user via the HMI.

### BRIEF DESCRIPTION OF THE DRAWINGS

FIG. 1 is a schematic diagram of an example of a chatbot system that includes a human-machine interface (HMI) and a dialogue computer, according to one embodiment.

FIG. 2 is a schematic diagram of an embodiment of the dialogue computer.

FIG. 3 is a schematic diagram of an embodiment of the chatbot system wherein the HMI is an electronic personal assistant.

FIG. 4 is a process flow diagram of individual chatbots assigned to a compartmentalized task, according to an embodiment.

FIG. 5 is a process flow diagram illustrating different assistant chatbots can be shared by or assigned to different master chatbots, according to an embodiment.

FIG. 6 illustrates an example of a language model that may be used by the chatbot system, according to an embodiment.

FIG. 7 is a process flow diagram illustrating inputs from different users that are dispatched to different chatbots.

FIGS. 8A and 8B are process flow diagrams illustrating the chatbot system utilizing a master chatbot and an assistant chatbot together to process a user's requests.

FIG. 9 is a flowchart illustrating operation of a chatbot system according to an embodiment.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

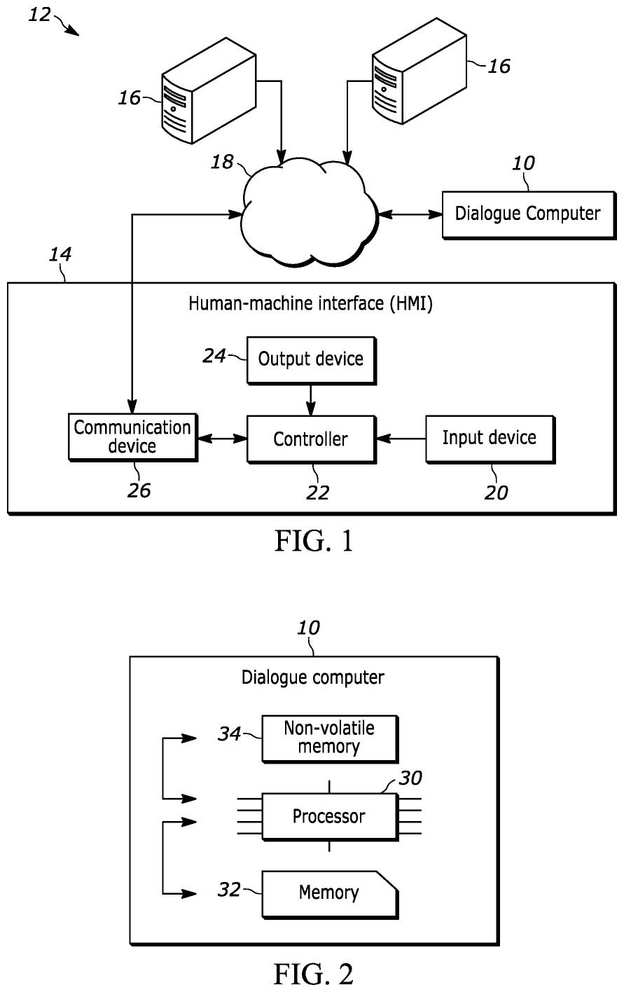

Turning now to the figures, wherein like reference numerals indicate like or similar features and/or functions, a dialogue computer 10 is shown for generating an answer to a query or question posed by a user (not shown). According to an example, FIG. 1 illustrates a question and answer (Q&A) system, or chatbot system 12 that comprises a human-machine interface (HMI) 14 for the user, one or more storage media devices 16 (two are shown by way of example only), the dialogue computer 10, and a communication network 18 that may facilitate data communication between the HMI 14, the storage media devices 16, and the dialogue computer 10. As will be explained in detail below, the user may provide his/her query via text, speech, or the like using HMI 14, and the query may be transmitted to dialogue computer 10 (e.g., via communication network 18). Upon receipt, the dialogue computer 10 may utilize a the chatbot system 12 disclosed herein, which may be a chatbot collaboration system (or chatbot routing system) for collaborating multiple chatbots in a single dialogue system. Using the chatbot routing system improves question and answer accuracy, as systems with a single chatbot may lack an ability to properly estimate an accurate statistical salience of a determination. The dialogue computer 10 described herein improves the user experience; for example, by providing more accurate responses to user queries, users are less likely to become frustrated with a system that provides a computer-generated response.

A user of the Q&A system 12 may be a human being which communicates a query (i.e., a question) with a desire to receive a corresponding response. According to one embodiment, the query may regard any suitable subject matter. In other embodiments, the query may pertain to a predefined category of information (e.g., customer technical support for a product or service, ordering food, etc.). These are merely examples; other embodiments also exist and are contemplated herein. An example process of providing an answer to the user's query will be described following a description of illustrative elements of system 12.

Human-machine interface (HMI) 14 may comprise any suitable electronic input-output device which is capable of: receiving a query from a user, communicating with dialogue computer 10 in response to the query, receiving an answer from dialogue computer 10, and in response, providing the answer to the user. According to the illustrated example of FIG. 1, the HMI 14 may comprise an input device 20, a controller 22, an output device 24, and a communication device 26. The HMI 14 may be, for example, an electronic personal assistant (e.g., an ECHO by AMAZON, HOMEPOD by APPLE, etc.) or a digital personal assistant (e.g., ALEXA by AMAZON, CORTANA by MICROSOFT, SIRI by APPLE, etc.) on a mobile device. In other embodiments, the HMI may be an internet web browser configured to communicate information back and forth between the user and the service provider. For example, the HMI 14 may be embodied on a website for a general store, restaurant, hardware store, etc.).

Input device 20 may comprise one or more electronic input components for receiving a query from the user. Non-limiting examples of input components include: a microphone, a keyboard, a camera or sensor, an electronic touch screen, switches, knobs, or other hand-operated controls, and the like. Thus, via the input device 20, HMI 14 may receive the query from user via any suitable communication format—e.g., in the form of typed text, uttered speech, user-selected symbols, image data (e.g., camera or video data), sign-language, a combination thereof, or the like. Further, the query may be received in any suitable language.

Controller 22 may be any electronic control circuit configured to interact with and/or control the input device 20, the output device 24, and/or the communication device 26. It may comprise a microprocessor, a field-programmable gate array (FPGA), or the like; however, in some examples only discrete circuit elements are used. According to an example, controller 22 may utilize any suitable software as well (e.g., non-limiting examples include: DialogFlow™, a Microsoft chatbot framework, and Cognigy™). While not shown here, in some implementations, the dialogue computer 10 may communicate directly with controller 22. Further, in at least one example, controller 22 may be programmed with software instructions that comprise—in response to receiving at least some image data—determining user gestures and reading the user's lips. The controller 22 may provide the query to the dialogue computer 10 via the communication device 26. In some instances, the controller 22 may extract portions of the query and provide these portions to the dialogue computer 10—e.g., controller 22 may extract a subject of the sentence, a predicate of the sentence, an action of the sentence, a direct object of the sentence, etc.

Output device 24 may comprise one or more electronic output components for presenting an answer to the user, wherein the answer corresponds with a query received via the input device 20. Non-limiting examples of output components include: a loudspeaker, an electronic display (e.g., screen, touchscreen), or the like. In this manner, when the dialogue computer 10 provides an answer to the query, HMI 14 may use the output device 24 to present the answer to the user according to any suitable format. Non-limiting examples include presenting the user with the answer in the form of audible speech, displayed text, one or more symbol images, a sign language video clip, or a combination thereof

Communication device 26 may comprise any electronic hardware necessary to facilitate communication between dialogue computer 10 and at least one of controller 22, input device 20, or output device 24. Non-limiting examples of communication device 26 include: a router, a modem, a cellular chipset, a satellite chipset, a short-range wireless chipset (e.g., facilitating Wi-Fi, Bluetooth, dedicated short-range communication (DSRC) or the like), or a combination thereof. In at least one example, the communication device 26 is optional. For example, dialogue computer 10 could communicate directly with the controller 22, input device 20, and/or output device 24.

Storage media devices 16 may be any suitable writable and/or non-writable storage media communicatively coupled to the dialogue computer 10. While two are shown in FIG. 1, more or fewer may be used in other embodiments. According to at least one example, the hardware of each storage media device 16 may be similar or identical to one another; however, this is not required. According to an example, storage media device(s) 16 may be (or form part of) a database, a computer server, a push or pull notification server, or the like. In at least one example, storage media device(s) 16 comprise non-volatile memory; however, in other examples, they may comprise volatile memory instead of or in combination with non-volatile memory. Storage media device(s) 16 (or other computer hardware associated with devices 16) may be configured to provide data to dialogue computer 10 (e.g., via communication network 18). The data provided by storage media device(s) 16 may enable the operation of chatbots using structured data, unstructured data, or a combination thereof however, in at least one embodiment, each storage media device 16 stores and/or communicates some type of unstructured data to dialogue computer 10.

Structured data may be data that is labeled and/or organized by field within an electronic record or electronic file. The structured data may include one or more knowledge graphs (e.g., having a plurality of nodes (each node defining a different subject matter domain), wherein some of the nodes are interconnected by at least one relation), a data array (an array of elements in a specific order), metadata (e.g., having a resource name, a resource description, a unique identifier, an author, and the like), a linked list (a linear collection of nodes of any type, wherein the nodes have a value and also may point to another node in the list), a tuple (an aggregate data structure), and an object (a structure that has fields and methods which operate on the data within the fields). In short, the structured data may be broken into classifications, where each classification of data may be assigned to a particular chatbot. For example, as will be described further herein, a “food” chatbot may include data enabling the system to respond to a user's query with information about food, while a “drinks” chatbot may include data enabling the system to respond to the user's query with information about drinks. Each master chatbot and assistant chatbot disclosed herein may be in structured data stored in storage media device 16, or in the dialogue computer 10 in memory 32 and/or 34 and accessed and processed by processor 30.

The structured data may include one or more knowledge types. Non-limiting examples include: a declarative commonsense knowledge type (scope comprising factual knowledge; e.g., “the sky is blue,” “Paris is in France,” etc.); a taxonomic knowledge type (scope comprising classification; e.g., football players are athletes,” “cats are mammals,” etc.); a relational knowledge type (e.g., scope comprising relationships; e.g., “the nose is part of the head,” “handwriting requires a hand and a writing instrument,” etc.); a procedural knowledge type (scope comprising prescriptive knowledge, a.k.a., order of operations; e.g., “one needs an oven before baking cakes,” “the electricity should be disconnected while the switch is being repaired,” etc.); a sentiment knowledge type (scope comprising human sentiments; e.g., “rushing to the hospital makes people worried,” “being on vacation makes people relaxed,” etc.); and a metaphorical knowledge type (scope comprising idiomatic structures; e.g., “time flies,” “it's raining cats and dogs,” etc.).

Unstructured data may be information that is not organized in a pre-defined manner (i.e., which is not structured data). Non-limiting examples of unstructured data include text data, electronic mail (e-mail) data, social media data, internet forum data, image data, mobile device data, communication data, and media data, just to name a few. Text data may comprise word processing files, spreadsheet files, presentation files, message field information of e-mail files, data logs, etc. Electronic mail (e-mail) data may comprise any unstructured data of e-mail (e.g., a body of an e-mail message). Social media data may comprise information from commercial websites such as Facebook™, Twitter™, LinkedIn™, etc. Internet forum data (e.g., also called message board data) may comprise online discussion information (of a website) wherein the website presents saved written communications of forum users (these written communications may be organized or curated by topic); in some examples, forum data may comprise a question and one or more public answers (e.g., question and answer (Q&A) data). Of course, Q&A data may form parts of other data types as well. Image data may comprise information from commercial websites such as YouTube™, Instagram™, other photo-sharing sites, and the like. Mobile device data may comprise Short Message System (SMS) or other short message data, mobile device location data, etc. Communication data may comprise chat data, instant message data, phone recording data, collaborative software data, etc. And media data may comprise Motion Pictures Expert Group (MPEG) Audio Layer IIIs (MP3s), digital photos, audio files, video files (e.g., including video clips (e.g., a series of one or more frames of a video file)), etc.; and some media data may overlap with image data. These are merely examples of unstructured data; other examples also exist. Further, these and other suitable types of unstructured data may be received by the dialogue computer 10—receipt may occur concurrently or otherwise.

As shown in FIGS. 1 and 2, dialogue computer 10 may be any suitable computing device that is programmed or otherwise configured to receive a query from the input device 20 (e.g., from HMI 14) and provide an answer using a neural network or machine learning that employs a language model. The chatbot system 12 may comprise any suitable computing components. According to an example, dialogue computer 10 comprises one or more processors 30 (only one is shown in the diagram for purposes of illustration), memory 32 that may store data received from the user and/or the storage media devices 16, and non-volatile memory 34 that may store data and/or a plurality of instructions executable by processor(s) 30.

Processor(s) 30 may be programmed to process and/or execute digital instructions to carry out at least some of the tasks described herein. Non-limiting examples of processor(s) 30 include one or more of a microprocessor, a microcontroller or controller, an application specific integrated circuit (ASIC), a field-programmable gate array (FPGA), one or more electrical circuits comprising discrete digital and/or analog electronic components arranged to perform predetermined tasks or instructions, etc.—just to name a few. In at least one example, processor(s) 30 read from memory 32 and/or non-volatile memory 34 and execute multiple sets of instructions which may be embodied as a computer program product stored on a non-transitory computer-readable storage medium (e.g., such as in non-volatile memory 34). Some non-limiting examples of instructions are described in the process(es) below and illustrated in the drawings. These and other instructions may be executed in any suitable sequence unless otherwise stated. The instructions and the example processes described below are merely embodiments and are not intended to be limiting.

Memory 32 may include any non-transitory computer usable or readable medium, which may include one or more storage devices or storage articles. Exemplary non-transitory computer usable storage devices include conventional hard disk, solid-state memory, random access memory (RAM), read-only memory (ROM), erasable programmable read-only memory (EPROM), electrically erasable programmable read-only memory (EEPROM), as well as any other volatile or non-volatile media. Non-volatile media include, for example, optical or magnetic disks and other persistent memory, and volatile media, for example, also may include dynamic random-access memory (DRAM). These storage devices are non-limiting examples; e.g., other forms of computer-readable media exist and include magnetic media, compact disc ROM (CD-ROMs), digital video disc (DVDs), other optical media, any suitable memory chip or cartridge, or any other medium from which a computer can read. As discussed above, memory 32 may store one or more sets of instructions which may be embodied as software, firmware, or other suitable programming instructions executable by the processor(s) 30—including but not limited to the instruction examples set forth herein. In operation, processor(s) 30 may read data from and/or write data to memory 32. Instructions executable by the processor(s) 30 may include instructions to receive an input (e.g., utterance or typed language), utilize a language model to unpack the input and determine what is the intent of the user, select a corresponding chatbot for interacting and processing the input and providing a responsive output to the user, as will be described more fully herein.

Non-volatile memory 34 may comprise ROM, EPROM, EEPROM, CD-ROM, DVD, and other suitable non-volatile memory devices. Further, as memory 32 may comprise both volatile and non-volatile memory devices, in at least one example additional non-volatile memory 34 may be optional.

While FIG. 1 illustrates an example of the HMI 14 that does not comprise the dialogue computer 10, in other embodiments the dialogue computer 10 may be part of the HMI 14 as well. In these examples, having dialogue computer local to and even sometimes within a common housing of the HMI 14 enables portable implementations of the system 12.

Communication network 18 facilitates electronic communication between dialogue computer 10, the storage media device(s) 16, and HMI 14. Communication network 18 may comprise a land network, a wireless network, or a combination thereof. For example, the land network may enable connectivity to public switched telephone network (PSTN) such as that used to provide hardwired telephony, packet-switched data communications, internet infrastructure, and the like. And for example, the wireless network may comprise cellular and/or satellite communication architecture covering potentially a wide geographic region. Thus, at least one example of a wireless communication network may comprise eNodeBs, serving gateways, base station transceivers, and the like.

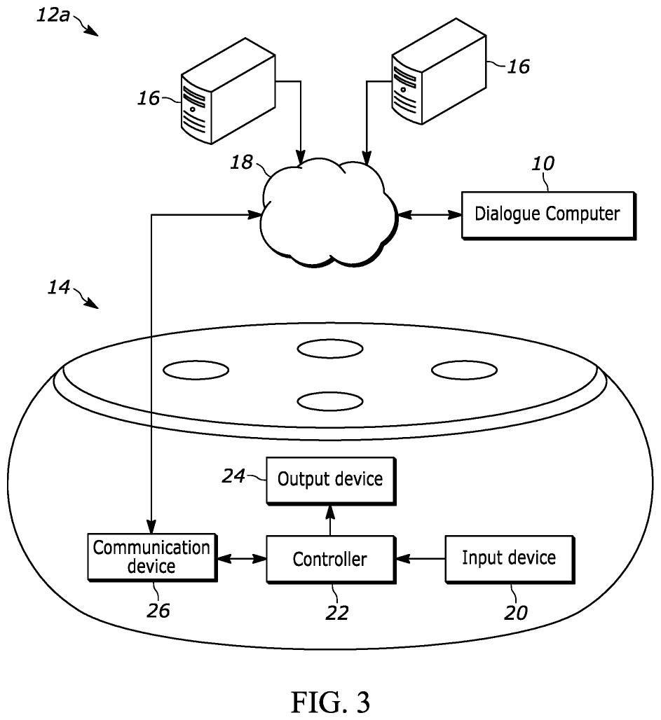

FIG. 3 illustrates one embodiment of a chatbot system 12 (e.g., Q&A system). According to the illustrated embodiment, the system 12 includes an HMI 14 that is an electronic personal assistant, such as one of the ones described above that includes the input device 20, the controller 22, the output device 24, and the communication device 26. The HMI 14 may be configured to receive any request from the user via input device 20, route the request to a proper chatbot for processing, process the request in the routed chatbot, and interact and provide feedback to the user via the output device 24.

The chatbot system 12 disclosed herein is an artificial intelligence (AI) based system that can imitate a conversation with users in their natural language. It can react to user's requests and, in turn, deliver a particular service. A single chatbot may be too small to fulfill needs of all kinds of business cases. A single chatbot is programmed and configured to focus on a narrow domain of expertise, and can only respond to inputs of a specific domain. For example, a chatbot trained to be a shopping assistant may tell a user where a certain product is in the store, but if the user asks where to find a restaurant, the chatbot may not be able to answer the question. It may not even understand what the question means.

Moreover, if too much information and processing capabilities is packed in a single chatbot, its training model will become extremely large; the training time and response time for each input increases dynamically. In addition, there is a practical upper bound on machine learning or AI-based capabilities in terms of the maximum number of intents and topics that can be handled within a single model. A meta-bot capable of handling any and all requests from a user may be extremely inefficient for at least these reasons.

Therefore, according to various embodiments described herein, the chatbot system 12 is designed with a master chatbot and one or more assistant chatbots. Each assistant chatbot is designed to focus on a narrow domain, and can be trained to handle inputs accordingly within that domain. The master chatbot can act as a chatbot itself by processing certain inputs itself to deliver an output, but can also route the inputs to an appropriate assistant chatbot for processing by that assistant chatbot's model.

For example, according to an embodiment, the chatbot system 12 may include a shopping assistant chatbot that interacts with customers to find things in the shopping mall. After shopping, the customer may feel tired, and need to get some food. The customer can ask the assistant chatbot to recommend some restaurants nearby, such as “I'm hungry, is there any food nearby?” In this case, a food recommendation assistant chatbot can take over the processing of such a request and perform the request by using its models to find an adequate restaurant. The food recommendation assistant chatbot may ask questions like “What kind of food are you hungry for?” Depending on the answer the customer gives, the food recommendation assistant chatbot can utilize its model to output an appropriate one or more recommendations for restaurants. The transition from the shopping assistant chatbot to the food recommendation assistant chatbot is seamless without giving the customer the inconvenience of beginning a new interaction (e.g., a new Q&A session).

To perform this, the chatbot system 12 utilizes a chatbot collaboration framework. Based on such a framework, the system 12 includes multiple assistant chatbots in the inside of the system 12, but only one input and one output channel is on the outside of the system. When users talk or otherwise provide input into the dialogue system, their input is automatically distributed to the proper chatbot. The user does not need to address a specific chatbot when they interact with the dialogue system, and doesn't even notice that there are multiple chatbots handling their requests internally.

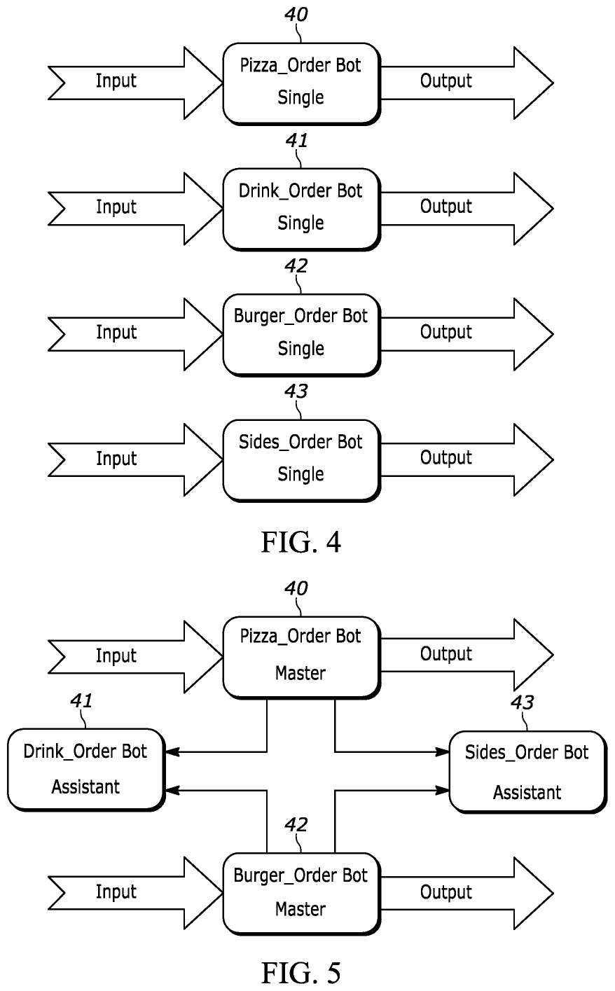

FIG. 4 illustrates a process flow diagram of individual chatbots assigned to a compartmentalized task, according to an embodiment. FIG. 4 shows four separate assistant chatbots 40-43. These chatbots may be designed by developers for a fast-food ordering system to deal with customer's orders and questions. Of course, in other embodiments the assistant chatbots can be designed and trained to handle any compartmentalized topic such as inputs dealing with music, movies, sports, clothing, purchasing goods on the Internet, and the like. In this illustrated embodiment involving food ordering in FIG. 4, the four chatbots 40-43 include a pizza_order chatbot 40 for interacting with a user regarding the user's desire to order a pizza, a drink_order chatbot 41 for interacting with the user regarding the user's desire to order a drink, a burger_order chatbot 42 for interacting with the user regarding the user's desire to order a burger, and a sides_order chatbot 43 for interacting with the user regarding the user's desire to order a side (e.g., fries). Each chatbot 40-43 can receive an input from the user regarding a desire to order something within the domain of that chatbot, and independently provide an output utilizing the trained model of that individual chatbot. While four chatbots 40-43 are illustrated, it should be understood that more or less than four chatbots can be provided in a given chatbot system 12.

If a fast-food restaurant wants to create its own dialogue system, it can pick and choose between different chatbots to include in its dialogue system based on its menu. For example, a pizza restaurant that does not serve burgers may only choose to subscribe or utilize the pizza_order chatbot 40, the drink_order chatbot 41, and the sides_order chatbot 43. The pizza_order chatbot 40 may be the master chatbot for that system. Master chatbots will be described further below. Likewise, a burger restaurant that does not serve pizza may only choose to subscribe or utilize the burger_order chatbot 42, the drink_order chatbot 41, and the sides_order chatbot 43. The burger_order chatbot 42 may be assigned as the master chatbot in this system. FIG. 5 illustrates such a situation in which multiple chatbot systems may utilize common or overlapping assistant chatbots. As provided herein, it may be desirable for the chosen chatbot system 12 to use only one master chatbot, and one or more assistant chatbots; a single chatbot system 12 may not use multiple master chatbots and FIG. 5 is merely illustrative of how different master chatbots may use assistant chatbots that other master chatbots also use.

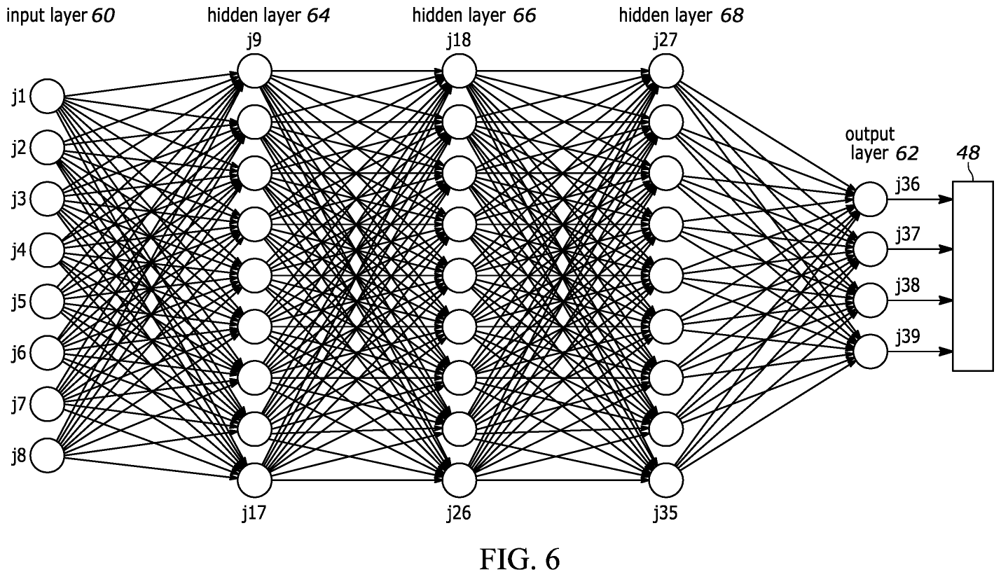

Each master chatbot and assistant chatbot within the chatbot system 12 may implement a language model. FIG. 6 illustrates an embodiment of a language model 44. As discussed above, the language model 44 may be a neural network (e.g., and in some cases, while not required, a deep neural network). The language model 44 may be configured as a data-oriented language model that uses a data-oriented approach to determine an answer to a question. Language model 44 may comprise an input layer 60 (comprising a plurality of input nodes, e.g., j1 to j8) and an output layer 62 (comprising a plurality of output nodes, e.g., j36 to j39). The illustrated quantities of input and output nodes are merely examples; other quantities may be used instead. In some examples, language model 44 may comprise one or more hidden layers (e.g., such as an illustrated hidden layer 64 (comprising a plurality of hidden nodes j9 to j17), an illustrated hidden layer 66 (comprising a plurality of hidden nodes j18 to j26), and an illustrated hidden layer 68 (comprising a plurality of hidden nodes j27 to j35). The nodes of the layers 60, 62, 64, 66, and 68 may be coupled to nodes of subsequent or previous layers. And each of the nodes j36 to j39 of the output layer 62 may execute an activation function—e.g., a function that contributes to whether the respective nodes should be activated to provide an output of the language model 44 (e.g., based on its relevance to the answer to the query). The quantities of nodes shown in the input, hidden, and output layers 60-68 of FIG. 6 is merely an example; any suitable quantities may be used.

According to the example shown in FIG. 6, output node values of at least some of the output nodes j36-j39 are provided to an output selection 48. Output selection 48 is configured to determine which of the answers provided by the output nodes j36-j39 should be selected as an answer the user's query or input. According to at least one non-limiting example, processor(s) 30 of dialogue computer 10 select the output node which has a highest probability value of a probability distribution. Thus, output selection 48 may be an electrical circuit which determines a highest probability value, software or firmware which determines the highest probability value, or a combination thereof.

Once the answer is selected, the answer is provided to the HMI 14. As described above, via at least one output device 24, the user is presented with the answer or output from the output selection 48. Thus, continuing with the example above, a user may approach HMI 14 (e.g., a digital personal assistant), utter a follow-up query via the input device 20, the controller 22 may provide the query to the communication device 26, the communication device 26 may transmit it to the dialogue computer 10, the dialogue computer 10 may execute the language model (as described above). Upon determination of an answer to the query, the dialogue computer 10 may provide the answer to the communication device 26, the communication device 26 may provide the answer to the controller 22, and the controller 22 may provide the answer to the output device 24, wherein the output device 24 may provide the answer (e.g., audibly or otherwise) to the user.

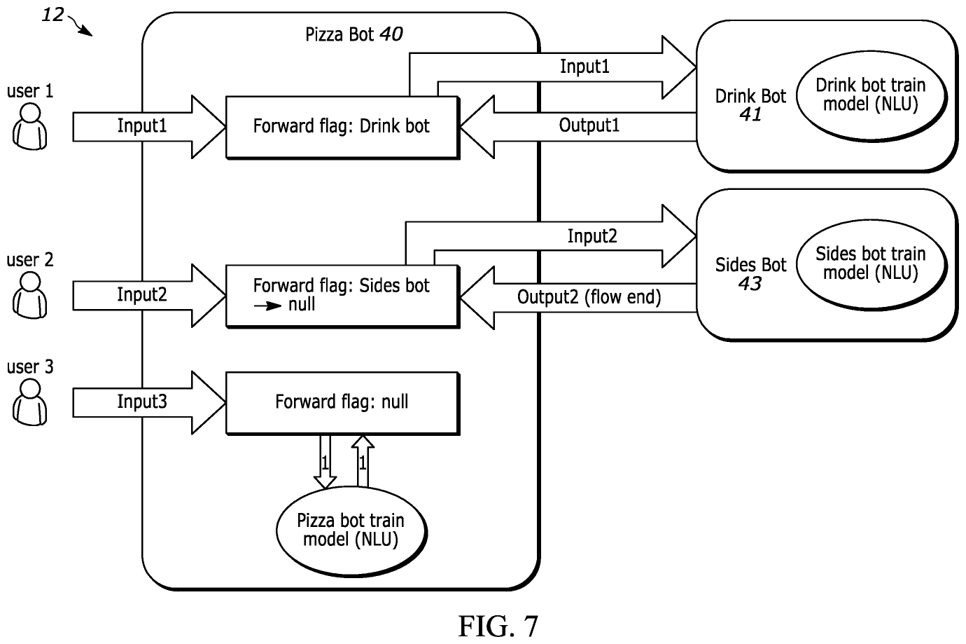

FIG. 7 illustrates a flow diagram of how forward flags are utilized to route the input to the correct assistant chatbot. In this embodiment, the chatbot system 12 is used for providing services for ordering menu items at a pizza restaurant, and thus the pizza_order chatbot 40 is utilized. The pizza_order chatbot 40 is designated as the master chatbot in this system. If the models described herein indicate the input from the user is for ordering a pizza, the pizza_order chatbot 40 can handle the request without routing the request to an assistant chatbot. If, however, the models indicate the input from the user is indicative of a desire to order a drink or a side item, then the pizza_order chatbot 40 can route the request to the drink_order chatbot 41 or the side_order chatbot 43, respectively, for processing.

The chatbot system 12 is configured to have all inputs be initially received and processed by the master chatbot, or routed to an appropriate assistant chatbot. However, certain inputs by the user may be difficult to interpret without appropriate context, especially once a conversation (e.g., Q&A session) has been initiated. Therefore, the chatbot system 12 is designed to utilize flags, or forward flags, to help the master chatbot route the input from the user to the appropriate assistant chatbot.

For example, in a pizza restaurant dialogue system shown in FIG. 7, the user might say something like “I want to order a coffee.” The trained model within the master chatbot (in this case, the pizza_order chatbot 40) can easily detect the intent of this utterance and dispatch the request to the drink_order chatbot 41 for processing. The drink_order chatbot 41 might need more information to fulfil the order, and so it may output a message back to the user such as “What size of coffee would you like?” The user can reply with an answer to that question (e.g., “Small”). Since all inputs are received by the master chatbot, it may be difficult for the master chatbot (e.g., pizza_order chatbot 40) to process or route this reply (“Small”) appropriately, without context. To mitigate this issue, forward flags are utilized in the master chatbot to help dispatch the input (e.g., “Small”) to the appropriate assistant chat. When the master chatbot detects a conversation flow starter intent, it enables the forward flag and forwards the request to the appropriate assistant chatbot. Once the flag is enabled, the mater chatbot will keep forwarding follow-up inputs from the same user to that assistant chatbot until the master chatbot receives a flow end result or an out-of-domain result from the assistant chatbot.

Reference is made to FIG. 7 to better illustrate the use of forward flags. In this example, a first user (user1) provides a first input (input1). For example, the user can say an utterance such as “I would like a drink.” The master chatbot (in this case, the pizza_order chatbot 40) identifies which domain the input belongs to, based on the input. The master chatbot determines that the user is desiring to order a drink, sets a forward flag indicating so. For example, in application, the master chatbot can set FORWARDFLAG=DRINK. And, the master chatbot forwards the input (input1) to the drink_order chatbot 41 for processing of the user's request. The assistant chatbot (e.g., drink_order chatbot 41) utilizes its trained model and provides an output (e.g., output1) back to the master chatbot (e.g., pizza_order chatbot 40). The output can be provided in natural language. The master chatbot can then send the user via the output device 24. Any subsequent requests by the user will, by default, be routed to the drink_order chatbot 41 due to the forward flag being set to that particular assistant chatbot (e.g., FORWARDFLAG=DRINK). This will continue until the master chatbot receives a flow end result (such as a completed order from the assistant chatbot), or until the assistant chatbot receives an out-of-domain result (e.g., an input from the user that is determined to not be related to the domain of that assistant chatbot, such as a side order not being related to the drink order).

In an embodiment, the master chatbot keeps separate forward flags for each user. In other words, when a new user provides an input, the forward flags are reset. When the master chatbot receives an input from the HMI, the master chatbot will first check the existence of any forward flag to decide whether the input should be routed to the respective assistant chatbot. The forward flag can be set dynamically during conversation based on the master chatbot model when it detects a flow starter intent, and can be disabled by the assistant chatbot with a flow end result. Also, in an embodiment, if the HMI does not receive any input for a time exceeding a threshold (e.g., 10 seconds), the forward flag can be reset.

Continuing with the Example illustrated in FIG. 7, a second user (user2) may provide a second input (input2). Since it is a new user making the request, the forward flag is reset. The master chatbot (e.g., pizza_order chatbot 40) determines that the input (input2) is regarding a request for a side item order, sets the forward flag to be active to that assistant chatbot (e.g., FORWARDFLAG=SIDE), and routes the input to the appropriate assistant chatbot (e.g., side_order chatbot 43). There, the side_order chatbot 43 processes the input using its trained model, and provides an output (output2) which can be in natural language. The master chatbot (e.g., pizza_order chatbot 40) may forward this output to the user (user2). Any subsequent request or input by the user (user2) can be, by default, handled by the side_order chatbot 43 assuming that flag remains active.

A third user (user3) may provide a third input (input3). Since it is a new user making the request, again the forward flag is reset. The master chatbot (e.g., pizza_order chatbot 40) decides that it can process the input itself because, for example, the input is relating to the subject matter that is appropriate for the master chatbot (e.g., a request to order a pizza). Thus, the master chatbot (e.g., pizza_order chatbot 40) processes the request using its own model, and provides an output accordingly. The forward flag can remain zero, or reset, since the master chatbot itself processed the input.

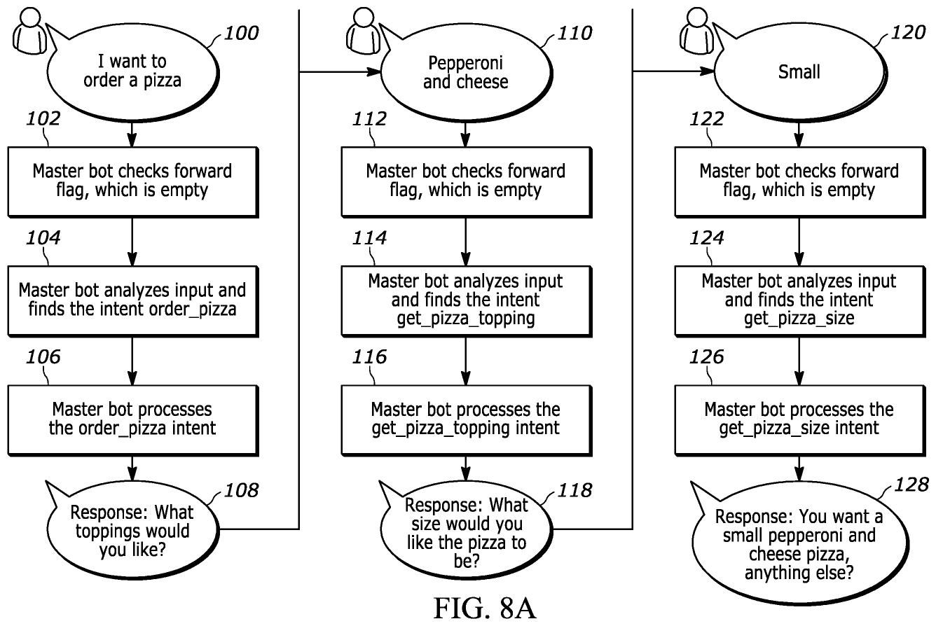

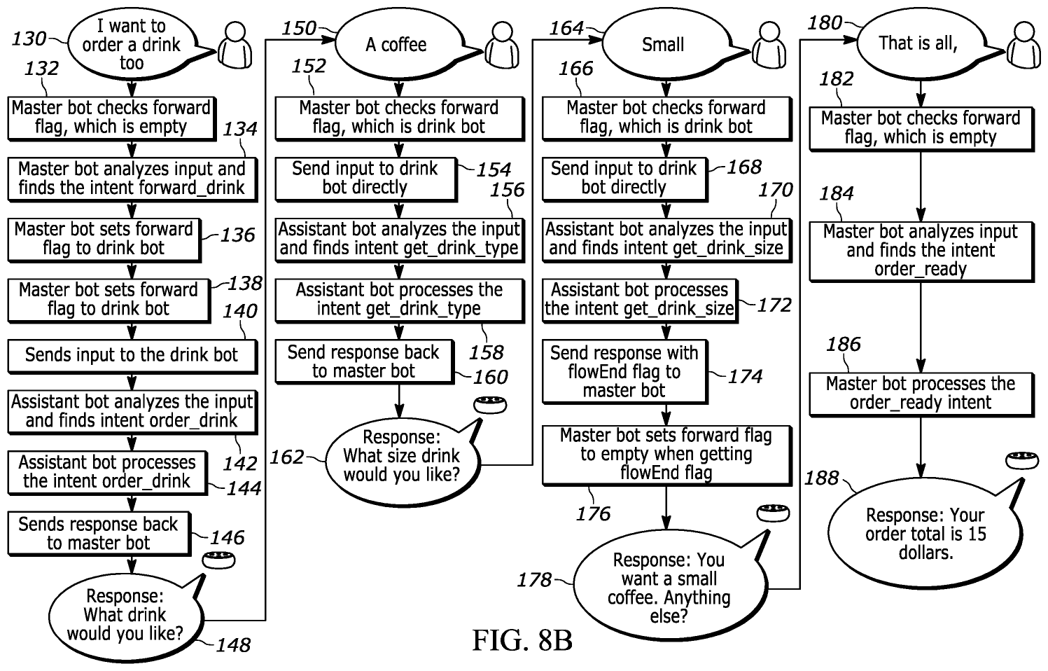

FIGS. 8A-8B provide a more illustrative example of a natural language conversation between a user and the chatbot system 12, wherein different inputs from the user are routed to appropriate assistant chatbots and respective forward flags are set. It should be understood that FIG. 8B is a continuation of FIG. 8A, and these are shown in two separate sheets simply due to the length of the flowchart. In this embodiment, a master chatbot (e.g., the pizza_order chatbot 40) is configured to receive inputs regarding pizza orders, and, if necessary, route various inputs to assistant chatbots which may include, for example, drink_order chatbot 41 among others.

At 100, a user provides an input to the HMI of the chatbot system 12 by methods described herein. In this example, the user says “I want to order a pizza.” The chatbot system 12 reacts at 102 by first checking to see if there is a forward flag present. In this embodiment, there is not a forward flag present because this is the beginning of a new Q&A conversation. At 104, because there is no forward flag present, the master chatbot uses its machine learning model to determine the utterance indicates an intent to order a pizza. Therefore, at 106, the master chatbot processes the intent to order a pizza, and finds an appropriate responds in its model. In this embodiment, the determined appropriate response is a question back to the user at 108 (e.g., via the HMI) being “What toppings would you like?”

This provides the user with an ability to interact again with the HMI again at 110. For example, the user states their desired toppings, such as “Pepperoni and cheese.” At 112, the master chatbot receives this utterance and again first checks to see if there is a forward flag present. Based on no forward flag being present, at 114 the master chatbot itself processes the utterance by, for example, matching the words spoken (e.g., “pepperoni” and “cheese”) with found words stored in the model. In other words, at 116, the master chatbot processes the determined intent as an indication to have a pizza with pepperoni and cheese on it. At 118, the master chatbot sends an output to the HMI for interaction with the user to indicate their desired size of pizza. This is an output of the trained model, as the model now understands that the user wants a pizza with pepperoni and cheese but does not know the size.

At 120, the user says “small” in response to the question posed by the HMI. At 122, the master chatbot again checks to see if a forward flag is present, and once again, one is not present. At 124, in response to no forward flag being set, the master chatbot processes the input and determines, via its model, that the user has indicated an intent to give a pizza size. At 126, in response to the determined intent being to get a pizza size, the master chatbot processes the request and determines the user is indicating they want a small sized pizza. At 128, after the master chatbot indicates a potential completion of a pizza order, the master chatbot can then cause the HMI to interact with the user by summarizing the order and asking if they want anything else, such as “You want a small pepperoni and cheese pizza. Anything else?”

The process now flows to FIG. 8B. At 130 the user has an utterance of “I want to order a drink too.” At 132, the master chatbot again checks to see if a forward flag is present, and once again, one is not present. At 134, since the forward flag is not set, the master chatbot processes the input and determines, via its model or by a recognized keyword in the utterance, that the user has indicated a desire to order a drink. For example, the master chatbot has detected a key word (e.g., “drink”) in the input, and thus determines an intent to order a drink. The master chatbot determines that the desire to order a drink matches with one of the assistant chatbots, in this case, drink_order chatbot 41. The master chatbot thus, at 136, sets a forward flag to the drink order (e.g.,

FORWARDFLAG=DRINK). At 138, the master chatbot sends the input (e.g., “I want to order a drink too”) to the drink_order chatbot 41 for processing. At 140, the assistant chatbot (e.g., drink_order chatbot 41) utilizes its own model to analyze the intent input, and at 142 determines that the user's intent is to order a drink by processing the input. At 144, the assistant chatbot has confirmed that it is the proper assistant chatbot to handle such a request by analyzing the intent of the input, and correspondingly processes the input to determine a proper output to be sent to the user. At 146, the output of the assistant chatbot's model (e.g., “What would you like to drink?”) is sent back to the master chatbot so that the master chatbot can deliver the output via the HMI, which is performed at 148.

At 150, the user provides an utterance of “Coffee.” At 152, the master chatbot again checks to see if a forward flag is present, and determines that the forward flag is actively set to drink (e.g., FORWARDFLAG=DRINK). In response to the forward flag being set, at 154 the master chatbot forwards the input to the appropriate assistant chat that matches the flag, in this case, the drink_order chabot 41. At 156, the assistant chatbot processes the input and determines, via its model, that the intent of the input is a type of drink, and at 158 the assistant chatbot retrieves the various types of drinks stored in its model and matches the input with one of the stored types of drinks, e.g., coffee. The assistant chatbot may store the request to get a coffee as part of the ordering system for purchase. The assistant chatbot may then realize that to complete the drink order, a size should be given (e.g., small, medium, large). This can be the output of the assistant chatbot. At 160, the output of the assistant chatbot is sent to the master chatbot for forwarding to the user via the HMI. Such an output is output to the user at 162. The output determined from the assistant chatbot may include information determined from previous processing steps which helps confirm the user's intent. For example, the output may be “What size of coffee would you like?” which includes the word “coffee” in the output when the real desire from the output is to determine the size of the coffee. This way, the user has confidence that the chatbot system 12 is operating correctly.

At 164, the user provides an utterance, e.g., “Small”. At 166, the master chatbot again checks to see if a forward flag is present, and determines that the forward flag is actively set to drink (e.g., FORWARDFLAG=DRINK). In response to the forward flag being set, at 168, the input is again sent directly to the respective assistant chatbot, e.g., drink_order chatbot 41. At 170, the assistant chatbot processes the input and determines, via its model, that the intent of the input is a size of drink, and at 172 the assistant chatbot retrieves the various sizes of drinks stored in its model (e.g., small, medium, large) and matches the input with one of the stored sizes of drinks, e.g., small. The assistant chatbot may then realize that the drink order is complete. Therefore, at 174 the assistant chatbot sets a signal to the master chatbot to reset the forward flag to empty, which can be done at 176. For example, at 174 the assistant chatbot may derive a “flowEnd” flag, indicating the current flow of Q&A is complete, which causes the master chatbot to reset its forward flag at 176 such that any next utterance may be initially processed by the master chatbot. At 174 the assistant chatbot may also send the output to the master chatbot such that the master chatbot can relay the output to the user via the HMI. In this case, at 178 the HMI asks the user if anything else is desired (e.g., “You want a small coffee. Anything else?).

At 180, the user provides an utterance, e.g., “That is all”. At 182, the master chatbot again checks to see if a forward flag is present, and determines that one is not present (due to it being reset at 176). Therefore, at 184 the master chatbot does not forward the input to an assistant chatbot and instead processes the input itself. The master chatbot, via its trained model, determines that the utterance indicates a desire to finalize the order (e.g., intent=order_ready) by matching the spoken utterance or intent with a corresponding output stored in the master chatbot model at 186. In response to the order being determined as finalized or ready, at 188 the master chatbot totals the cost of the inputs (e.g., a small pepperoni and cheese pizza, and a small coffee) as fifteen dollars, and outputs this to the user via the HMI (e.g., “Your order total is 15 dollars).

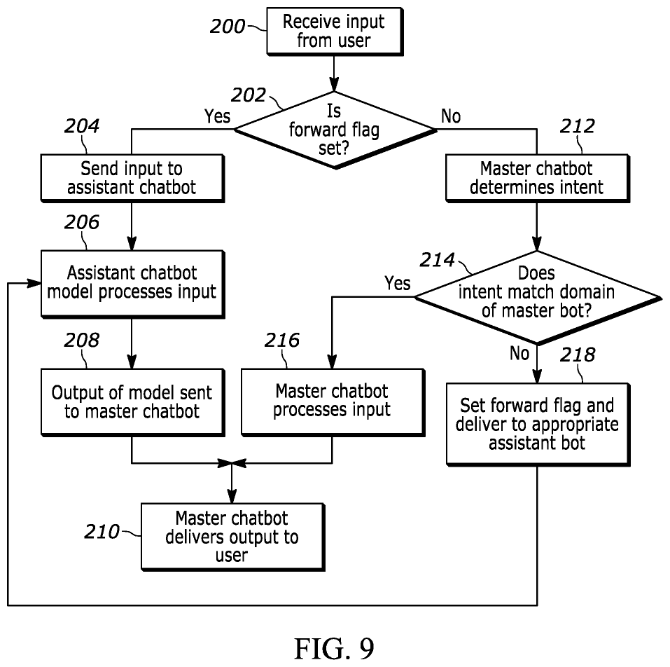

FIG. 9 illustrates a flow diagram of the hierarchy of the chatbot system 12, and the relationship between the master chatbot and the assistant chatbots, according to an embodiment. At 200, the HMI receives an input from the user. This can be utilizing the input device 20 described above, such as a microphone or a keyboard. The input is sent to the master chatbot. At 202, the master chatbot determines if a forward flag has been set to a respective assistant chatbot, or if the forward flag is empty. If the forward flag has been set, then at 204 the master chatbot sends the input directly to the assistant chatbot matching with the forward flag. At 206, the assistant chatbot then utilizes its model to process the input. This can be done via the trained model systems described herein, such as using a language model 44 and other models to match the words with a corresponding intent of the user. At 208, the output of the assistant chatbot's model is sent to the master chatbot. At 210, this output is delivered to the user via, for example, output device 24 which can be a speaker, screen, or the like as described above.

Returning to 202, if the master chatbot determines that a forward flag has not been set, then at 212 the master chatbot itself determines the intent of the user. For example, the master chatbot can use its own trained model to match the input of the user with a stored intent, such as an intent to order food, order a drink, buy clothing, get directions to a place, call a person, etc. In short, depending on the size and capabilities of the master chatbot, it may be able to match any input with a stored desired intent of any different. Of course, this may depend on how many assistant chatbots are utilized in the chatbot system 12, or how many assistant chatbots are subscribed into the system. If an input does not match a corresponding stored intent in the chatbot system 12, the master chatbot can alert the user of that. The master chatbot can utilize its own model, such as language model 44 or other models to match the words of the input with a corresponding intent of the user. The master chatbot may have its own domain of expertise for processing, such as the examples above in which the master chatbot is a pizza_order chatbot 40. At 214, the master chatbot determines whether the determined intent of the user matches the domain of the master chatbot. If the answer is yes, then at 216 the master chatbot utilizes its own trained model to determine an appropriate output based on the input. If the answer to 214 is no, then the master chatbot determines which assistant chatbot is appropriate to process such an input, sets a forward flag that matches the appropriate assistant chatbot, and delivers the input to that assistant chatbot. The assistant chatbot can then process the input at 206 as explained above.

The disclosure provided herein has made reference to the identification of “intent” of the user. Assistant chatbots can use their trained models to identify a flow-starting intent of its own domain. But, for the master bot, since it fulfills a job of dispatching the request to the corresponding assistant chatbot, it needs to identify flow starting intents for all chatbots. Thus, when a new assistant chatbot is added into the chatbot system 12 (e.g., it is “registered” to the system), the master chatbot must extend its training model to include some intents to indicate the flow-starting points of the new assistant chatbot. Those intents can be referred to as forward intents.

When an assistant chatbot is registered to the master chatbot, a set of forward intents are added into the knowledge of the master chatbot. In embodiments, those forward intents cover all starting points of dialogue flows belonging to the assistant chatbot. The forward intents added to the master chatbot can be copied from the knowledge of the assistant chatbot directly. Or, developers can create new forward intents for the master chatbot which are triggered by pre-defined keywords. For example, as the models are trained, various key words in an utterance input into the system can indicate an intent to order food; a single utterance having the word “eat,” “food,” “hungry,” “pizza,” or “restaurant,” coupled with the word “order,” “buy,” “pay,” or the like may indicate a desire to order food. Again, these are merely example utterances, and additional key words can be added and/or the model within the master chatbot can be trained to determine the intent of the utterance input. In addition, the forward intent should include the address of the assistant chatbot. Therefore, when the master chatbot detects the forward intent, it knows where to dispatch the input.

For instance, in the pizza restaurant dialogue system disclosed herein and described with reference to FIGS. 7-8, when the drink_order chatbot 41 is registered be an assistant chatbot to the master pizza_order chatbot 40, a new intent (e.g., forward_drink) is added into the pizza_order chatbot 40. This is a forward intent and triggered by keywords, such as “drink,” “beverage,” “COKE,” “PEPSI,” “coffee,” “thirsty,” etc. When one of these key words is detected as part of the input, the master chatbot may route the input to the appropriate assistant chatbot, in this case, the drink_order chatbot 41.

The processes, methods, or algorithms disclosed herein can be deliverable to implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as ROM devices and information alterably stored on writeable storage media such as floppy disks, magnetic tapes, CDs, RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

1. A method for collaborating multiple chatbots in a dialogue setting, the method comprising:
at a master chatbot, receiving a first input from a user;
at the master chatbot, determining a first intent of the user based on the first input;
in response to the master chatbot determining the first intent of the user matches a domain of the master chatbot, processing the first input via a first machine-learning model at the master chatbot;
receiving a second input from the user at the master chatbot;
at the master chatbot, determining a second intent of the user based on the second input;
in response to the master chatbot determining the second intent of the user matches a domain of an assistant chatbot that is one of a plurality of user-subscribed assistant chatbots in communication with the master chatbot:
setting a forward flag that corresponds to the assistant chatbot,
forwarding the second input to the assistant chatbot for processing, and
processing the second input via a second machine-learning model at the assistant chatbot;
receiving a third input from the user at the master chatbot;
based upon the forward flag being set, forwarding the third input to the assistant chatbot for processing; and
resetting the forward flag in response to the assistant chatbot determining an end of conversation or out-of-domain input in the third input.

2. The method of claim 1, wherein the processing of the first input at the master chatbot includes utilizing the first machine-learning model within the master chatbot to determine a first output; and
the method further comprising delivering the first output to the user via a human-machine interface (HMI).

3. The method of claim 2, wherein the processing of the second input at the assistant chatbot includes utilizing the second machine-learning model within the assistant chatbot to determine a second output; and
the method further comprising delivering the second output to the user via the HMI.

4. The method of claim 1, wherein the determining of the first intent of the user is performed at the master chatbot by matching a first key word of the first input with a corresponding word stored in a database, and wherein the determining of the second intent of the user is performed at the master chatbot by matching a second key word of the second input with a corresponding word stored in the database.

5. (canceled)

6. The method of claim 1, wherein the step of forwarding the third input is performed by the master chatbot without the master chatbot determining a third intent of the user based on the third input.

7. (canceled)

8. A non-transitory computer-readable storage medium comprising instructions that, when executed by at least one processor, cause the at least one processor to:
at a master chatbot, receive an input from a user;
at the master chatbot, determine an intent of the user based on the input;
in response to the master chatbot determining the intent of the user is a first intent that matches a first domain of the master chatbot:
transform the input into a first output at the master chatbot utilizing a first machine-learning model, and
deliver the first output to the user from the master chatbot; and
in response to the master chatbot determining the intent of the user is a second intent that matches a second domain of an assistant chatbot in communication with the master chatbot, wherein the assistant chatbot is one of a plurality of user-subscribed assistant chatbots:
set a forward flag to correspond with the assistant chatbot,
forward the input to the assistant chatbot,
transform the input into a second output at the assistant chatbot utilizing a second machine-learning model,
send the second output from the assistant chatbot to the master chatbot, and
deliver the second output to the user from the master chatbot;
receive a third input from the user at the master chatbot; and
based upon the forward flag being set to correspond with the assistant chatbot, forwarding the third input to the assistant chatbot for processing;
receive a fourth input at the master chatbot; and
determine the intent of the fourth input based on the forward flag being reset.

9. The non-transitory computer-readable storage medium of claim 8, further comprising instructions that, when executed by at least one processor, cause the at least one processor to deliver the first output and the second output to the user via a human-machine interface (HMI).

10. The non-transitory computer-readable storage medium of claim 8,
wherein the determination of the intent of the user is the first intent is performed at the master chatbot by matching a first key word of the input with a corresponding first word stored in a database, and
wherein the determination of the intent of the user is the second intent is performed at the master chatbot by matching a second key word of the input with a corresponding second word stored in the database.

11. (canceled)

12. The non-transitory computer-readable storage medium of claim 8, wherein the forwarding of the third input to the assistant chatbot is performed without the master chatbot determining the intent of the user.

13. The non-transitory computer-readable storage medium of claim 8, further comprising instructions that, when executed by at least one processor, cause the at least one processor to:
reset the forward flag in response to the assistant chatbot determining an end of conversation or out-of-domain input in the third input.

14. (canceled)

15. A system for collaborating multiple chatbots in a dialogue setting, the system comprising:
a human-machine interface (HMI) configured to receive input from and provide output to a user; and
one or more processors in communication with the HMI and programmed to:
receive an input from the user via the HMI;
at a master chatbot, determine an intent of the input;
at the master chatbot, match the intent of the input with a domain of an assistant chatbot that is one of a plurality of user-subscribed assistant chatbots;
set a forward flag that corresponds to the assistant chatbot;
at the assistant chatbot, process the input to derive an output utilizing a machine-learning model;
send the output from the assistant chatbot to the master chatbot;
deliver the output from the master chatbot to the user via the HMI;
receive a second input from the user via the HMI; and
forward the second input to the assistant chatbot based on the forward flag being set; and
reset the forward flag in response to the assistant chatbot determining an end of conversation or out-of-domain input in the second input.

16. (canceled)

17. The system of claim 15, wherein one or more processors is programmed to forward the second input to the assistant chatbot without determining the intent of the input based on the forward flag being set.

18. (canceled)

19. The system of claim 15, wherein the one or more processors is further programmed to:
receive a third input from the user via the HMI; and
at the master chatbot, determine an intent of the input based on the forward flag being reset.

20. The system of claim 19, wherein the one or more processors is further programmed to:
in response to the intent of the input matching a domain of the master chatbot, process the third input to derive a corresponding output at the master chatbot; and
outputting the corresponding output to the user via the HMI.

21. The method of claim 1, wherein the user selects the user-subscribed assistant chatbots to create a customized chatbot system.

22. The method of claim 1, further comprising:
selecting the user-subscribed assistant chatbots to create a customized chatbot system.

23. The non-transitory computer-readable storage medium of claim 8,
wherein the user selects the user-subscribed assistant chatbots to create a customized chatbot system.

24. The system of claim 15, wherein the one or more processors is further programmed to receive, from the user, a selection of the user-subscribed assistant chatbots.
